(19) United States
(12) Patent Application Publication
(10) Pub. No.: US 2004/0242077 A1
(43) Pub. Date: Dec. 2, 2004

(54) Connector with an electrical module

(76) Inventor: Chih-Kai Chang, Taoyuan Hsien (TW)

Correspondence Address: BIRCH STEWART KOLASCH & BIRCH, PO BOX 747, FALLS CHURCH, VA, 22040-0747, US

(21) Appl. No.: 10/449,506

(22) Filed: Jun. 2, 2003

(51) Int. Cl. H01R 24/00

(52) U.S. Cl. 439/676

(57) ABSTRACT

A connector with an electrical module is provided. The connector with an electrical module comprises an isolation chassis that comprises a frame and a terminal set in the frame, and a receiving space is formed between the terminal set and the frame for receiving and positioning an electric module securely. The receiving space is for receiving and covering the electric module that is positioned on the surface of the circuit board. Therefore the electric module can be positioned steadily within the receiving space and therefore gluing process into the receiving space for fixing the electric module can be carried out without altering the position of the electric module. Further, the frame functions as a shield of the electric module.

### BACKGROUND OF THE INVENTION

1. The field of the invention

The present invention relates to a connector, and more particularly relates to a connector with an electrical module comprising an isolation chassis that comprises a frame and a terminal set in the frame, and a receiving space is formed between the terminal set and the frame for receiving and positioning an electric module securely.

2. Description of the related art

With the rapid development in information technology, the computer products, for example, desktop computer and notebook computer are essential nowadays. The user is able to retrieve or transmit documents by linking with the internet by using computer. The use of internet technology is not only convenient and also has no boundaries, and therefore computers have become the most essential resource for personal and enterprises use. In order for a computer to link with the Internet, suitable connectors are necessary. RJ 45 connectors are generally used for this purpose, however RJ 45 connectors generate high frequency that causes interferences with other electronic devices. The signal of the RJ 45 connector also experience interferences by the external transmission wire and signal interruptions. One conventional way of resolving the interference problems coat the connector with metallic coating and use an interference elimination module. However, presently the available connector with the interference elimination module is manufactured by attaching the interference elimination module on a circuit board as shown in FIG. 7. The connector has a terminal set that is combined with a plug B and a receiver D, which is inlayed into an isolation chassis A. The plug B comprises a plurality of terminals B1 and the receiver D comprises a plurality of terminals D1, wherein the plurality of terminals B1 and D1 are welded together and positioned vertically on the circuit board C, and a interference elimination module C1 is set on the rear side of the circuit board C. There is no fixing or securing element for positioning interference elimination module C1 in the connector, and therefore it highly difficult to implement a gluing process for positioning the interference elimination module C1 onto the circuit board C. Additionally, it is difficult to localize the interference elimination module C1 within a central region of the circuit board C. Consequently, the interference elimination module C1 may come into contact with the neighboring circuit or electrical components on the circuit board C and cause shorting of circuits. Furthermore, the interference elimination module C1 is assembled onto the surface of the connector so that the interference elimination module C1 is completely exposed, and therefore when a user attempts to install the connector or other electrical component that is peripherally adjacent to the connector, the interference elimination module C1 may easily get damaged. Accordingly, it is highly desirable to improve the structure of the connector in order to overcome the defects of the conventional art.

### SUMMARY OF THE INVENTION

Accordingly, in the view of the foregoing, the present inventor makes a detailed study of related art to evaluate and consider, and uses years of accumulated experience in this field, and through several experiments, to create a new connector with an electrical module.

In accordance with the above objects and other advantages of the present invention, a connector with an electrical module is provided. The connector with an electrical module comprises an isolation chassis, a terminal set, a frame and an electric module. A receiving space is formed at a frontal side of the isolation chassis and a containing space is formed at the other side of the isolation chassis away from the receiving space. The terminal set has a connecting terminal with a plurality of bent portions at the frontal side, and the other side, has a buckling element with a protruded resilient buckle. A protruded positioning element that correspond to a through hole of the circuit board for positioning is formed on the surface of the terminal set, and two buckling hooks are bilaterally positioned on the frontal flange of the terminal set.

According to one aspect of the present invention, the receiving space is for receiving and covering the electric module that is positioned on the surface of the circuit board. Therefore the electric module can be positioned steadily within the receiving space and therefore gluing process into the receiving space for fixing the electric module can be carried out without altering the position of the electric module. Further, the frame functions as a shield of the electric module.

### BRIEF DESCRIPTION OF THE DRAWING

For a more complete understanding of the present invention, reference will now be made to the following detailed description of preferred embodiments taken in conjunction with the accompanying drawings, in which:

FIG. 1 is an exploded view of a connector with an electrical module of the present invention;

FIG. 2 is an exploded view of a terminal set and an isolation chassis of the present invention;

FIG. 3 is an elevational view of the terminal set and isolation chassis of the present invention;

FIG. 4 is a sectional side view showing before the assembly of the connector with an electrical module of the present invention;

FIG. 5 is a sectional side view showing while the assembly of the connector with an electrical module of the present invention;

FIG. 6 is a sectional side view showing after the assembly of the connector with an electrical module of the present invention; and

FIG. 7 is an exploded view of a conventional connector with an electrical module.

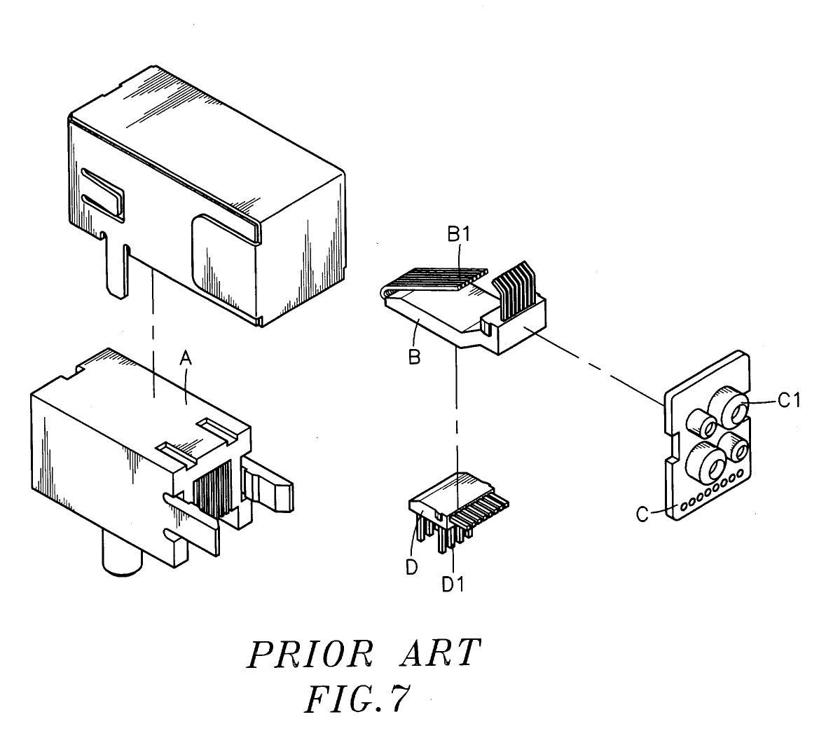

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

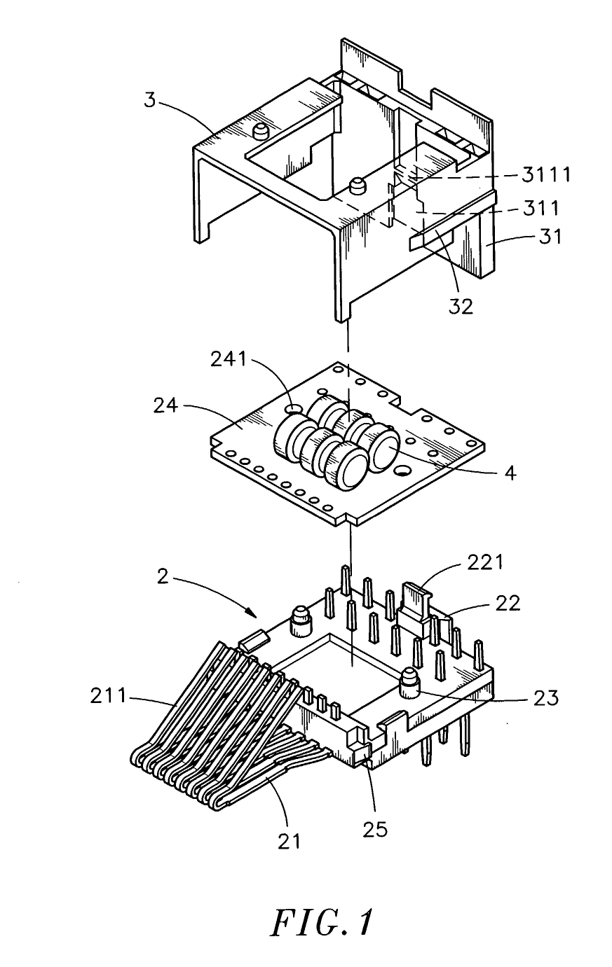

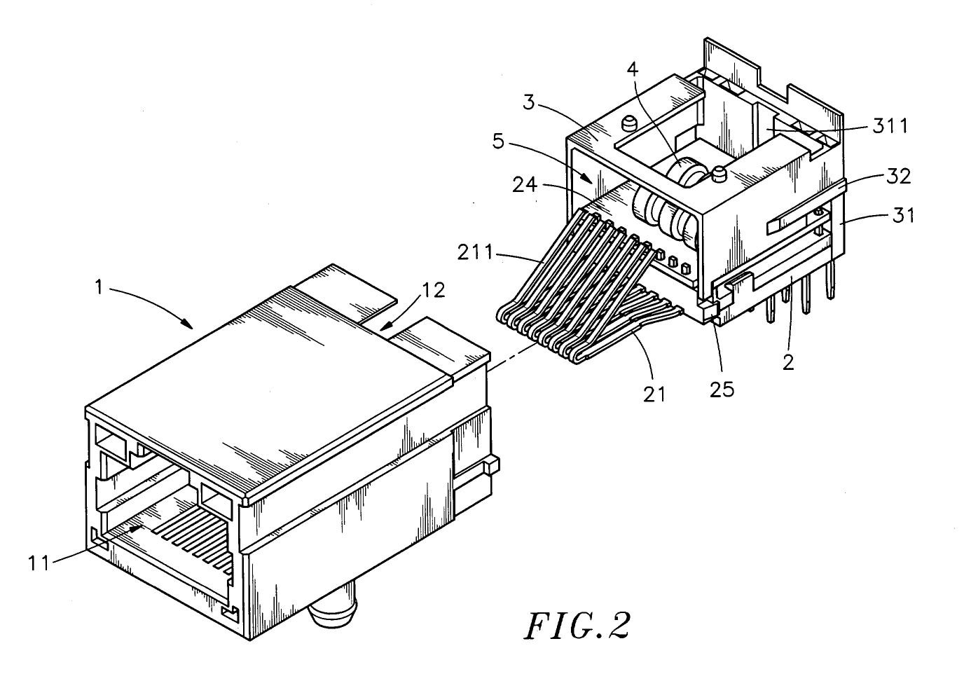

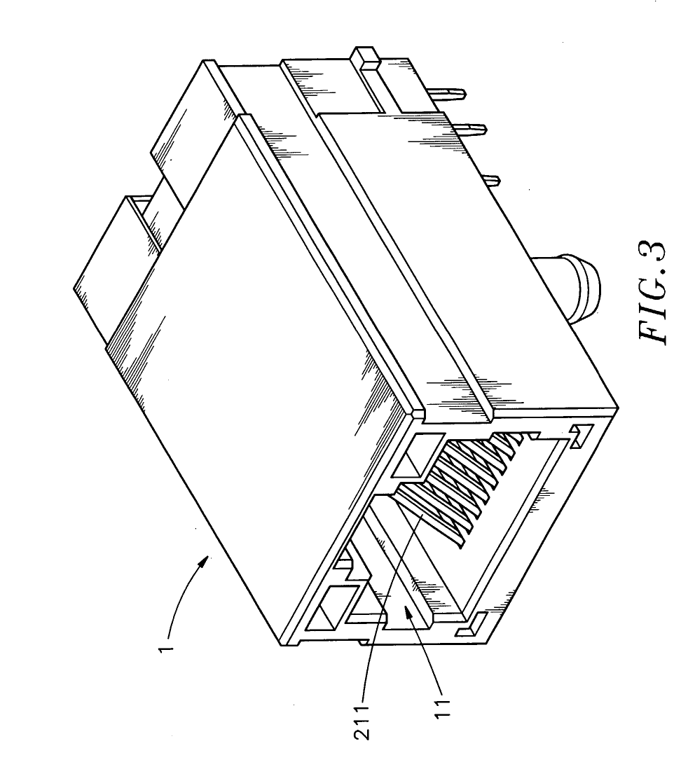

Referring to FIGS. 1, 2 and 3, the structure of the connector with an electrical module comprises an isolation chassis 1, a terminal set 2, a frame 3 and an electric module 4. A receiving chamber 11 is formed at a frontal side of the isolation chassis 1 and a containing space 12 is formed at the other side of the isolation chassis 1 away from the receiving chamber 11. The terminal set 2 has a connecting terminal 21 with a plurality of bent portions 211 at the frontal side, and the other side, has a buckling element 22 with a protruded resilient buckle 221. A protruded positioning element 23 that correspond to a through hole 241 of the circuit board 24 for positioning is formed on the surface of the terminal set 2, and two buckling hooks 25 are bilaterally positioned on the frontal flange of the terminal set 2.

The frame 3 comprises a fitting portion 31 that has a buckling groove 311, a protruded buckling element 3111 is formed within the buckling groove 311 and on the outer flange of the frame 3 set with a fitting track 32.

Furthermore, the electric module 4 comprises a capacitor and an interference eliminator.

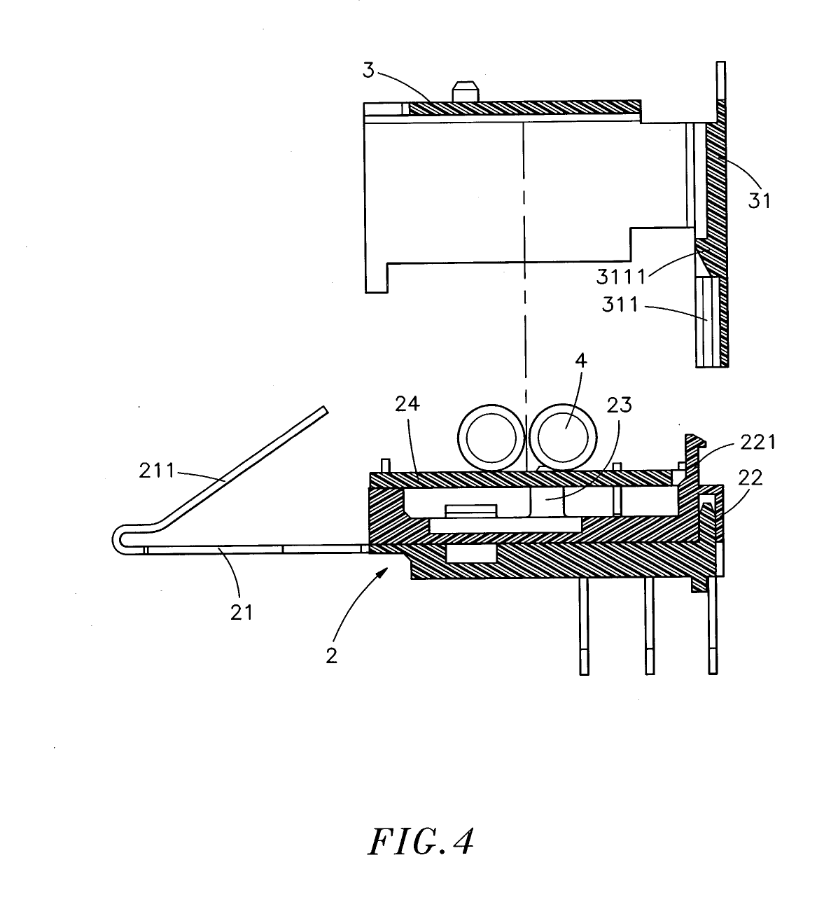

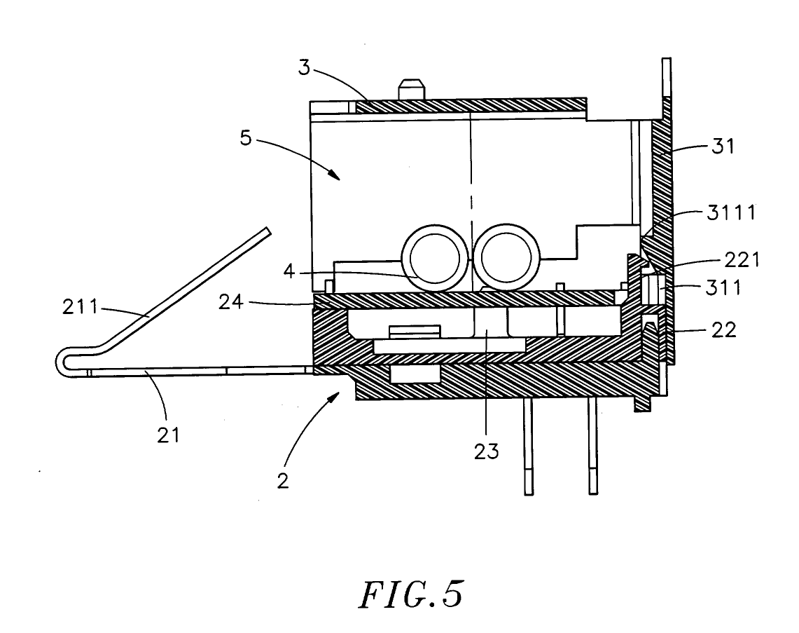

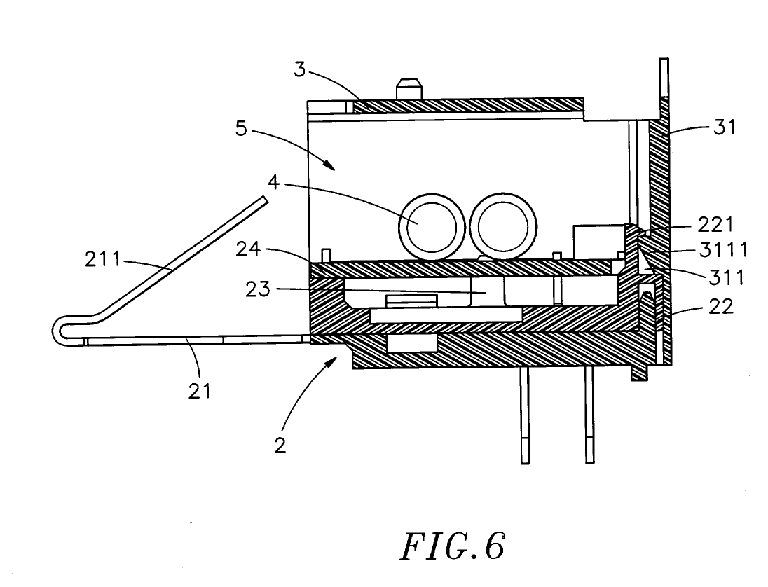

Referring to FIGS. 4, 5 and 6, the assembly of the connector with an electrical module of the present invention is described as follows. The electric module 4 is fixed onto the surface of the circuit board 24 of the terminal set 2, and then the buckling groove 311 of the fitting portion of the frame 3 which is positioned on the right side to the buckling element 22 of the terminal set 2 is placed then press down to make the buckling element 22 of the terminal set 2 inlay into the buckling groove 311 of the fitting portion of the frame 3. Next, the frame 3 is pressed down to make the resilient buckle 221 that is protruded on the surface of the buckling element 22 of the terminal set 2 supported on the buckling element 311, which is protruded within the buckling groove 311 to elastically deformation. Thus the resilient buckle 221 is able to return to its original position and gets supported by the buckling element 3111 of the buckling groove 311. And the button flange of the frame 3 is accordingly supported by the surface of the circuit board 24 of the terminal set 2 and a receiving space 5 will be formed therein.

The above receiving space 5 is formed for receiving and covering the electric module 4 that is positioned on the surface of the circuit board 24. Therefore the electric module 4 can be positioned steadily within the receiving space 5 and therefore gluing process into the receiving space 5 for positioning the electric module 4 can be carried out without altering the position of the electric module 4. Further, the frame 3 functions as a shield of the electric module 4. Additionally, after assembling the terminal set 2, frame 3 and the electric module 4, the terminal set 2 can be fitted into the containing space 12 of the isolation chassis 1 and the bent portion 211 of the connecting terminal 21 of the terminal set 2 can be positioned within the receiving chamber 11 formed at the frontal side of the isolation chassis 1.

The above assembly method is merely a best mode of carrying out the present invention and not for limiting the scope of the invention, and the present invention can also be practiced using RJ-45 or RJ-11 connector, and further a RJ-45 jack or a RJ-11 jack can be used to connect with the connector with an electrical module of the present invention. The present invention substantially has the advantage of including a receiving space 5 which is formed by positioning the terminal set 2 and frame 3, and the receiving space 5 is designed to receive the electric module 4 and then a glue layer is used to secure fix the electric module 4 onto circuit board 24. Accordingly, the present invention provides a simple structure of a connector that can be easily fabricated without a need of any special process or equipment and also can be easily assembled. As can be noted from the above description that the present invention provides a structure of a connector for positioning the electric module such that the electric module is not only protected from physical damage but also prevented from making undesirable electrical connection with the neighboring electrical components and thus the reliability of the connector can be effectively promoted.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A connector with an electric module comprising:
an isolation chassis:
a terminal set positioned within a containing space of said isolation chassis, wherein said terminal set comprises a plurality of bent connecting terminals positioned at its frontal side, the terminal set being movable in a first direction to be received within a receiving chamber located at a frontal side of said isolation chassis, and wherein said terminal set comprises a frame and a receiving space formed therein for receiving an electric module, the terminal set being insertable into the receiving space of the frame in a second direction, the first direction being perpendicular to the second direction; and
a circuit board for fixing on the terminal set having the electric module by performing a gluing process, wherein the electric module is steadily positioned within the terminal set.

2. The connector according to claim 1, wherein said frame comprises a fitting portion positioned vertically thereof on the rear side, said fitting portion comprises a buckling groove and said terminal set has buckling element formed at the distal end, said buckling element of the terminal set can fit into said buckling groove for positioning.

3. The connector according to claim 1, wherein said buckling groove of the fitting portion of said frame has a protruded element, and the buckling element of said terminal set has a protruded resilient buckle on a surface thereof, said resilient buckle is for buckling onto said buckling element of the buckling groove for positioning.

4. The connector according to claim 1, wherein said terminal set has a plurality of positioning elements protruding from a surface thereof for fitting into a corresponding through hole of said circuit board.

5. The connector according to claim 1, wherein said electric module comprises a capacitor.

6. The connector according to claim 1, wherein said electric module comprises an interference eliminator.

7. The connector according to claim 1, wherein said frame has a bottom flange supported against the surface of said terminal set.

8. The connector according to claim 1, wherein a RJ-45 jack can be used to connect with said connector.

9. The connector according to claim 1, wherein a RJ-11 jack can be used to connect with said connector.

10. The connector according to claim 2, wherein the buckling element of the terminal set is generally perpendicular to the circuit board and wherein the buckling element passes through a groove at a rear of the circuit board.

11. The connector according to claim 2, wherein the buckling groove of the fitting portion is on a rear side of the frame and wherein the buckling element of the terminal set is on a rear side of the terminal set, the rear side of the fitting position being adjacent to the rear side of the fitting portion.

12. The connector according to claim 11, wherein the bent connecting terminals are on a front side of the terminal set, the front side of the terminal set being an opposite side from the rear side.
